(19) United States
(12) Patent Application Publication
(10) Pub. No.: US 2006/0035515 A1
(43) Pub. Date: Feb. 16, 2006

(54) Connector arrangement between a flexible ribbon cable and a component

(76) Inventor: Thomas Bernhard Pabst, Nurnberg (DE)

Correspondence Address: HARRINGTON & SMITH, LLP, 4 RESEARCH DRIVE, SHELTON, CT, 06484-6212, US

(21) Appl. No.: 10/532,838

(22) PCT Filed: Oct. 29, 2003
(86) PCT No.: PCT/EP03/12004

§ 371 Date: Apr. 19, 2005

(30) Foreign Application Priority Data
Oct. 31, 2002 (DE) 102 50 933.6

(51) Int. Cl. H01R 12/24

(52) U.S. Cl. 439/492

(57) ABSTRACT

The invention relates to a connector arrangement, between a flexible ribbon cable (1) and a component (5) of an electrical circuit, whereby the flexible ribbon cable (1) has a stripped conductor region on one side of the end for connection, comprising a housing (2) in which the flexible ribbon cable end is clamped and in which an elastic element (3) subjects the stripped end to pressure. The component (5) comprises a socket (4) for the housing (2), in which the housing (2) may be clipped and with contact strips (6) arranged therein against which the stripped regions of the flexible ribbon cable (1) are pressed, when the housing (2) is in the terminal position thereof within the socket (4).

The present invention refers to a connector arrangement between a flat flex cable and a component of an electrical circuit in accordance with the preamble of patent claim 1. Such a connector arrangement is known from EP 0443655 A1.

Flat flex cables are finding ever-increasing application in bus systems—for example, in automobile manufacture. There, flat flex cables, which are connected to form ring circuits and by means of which a multiplex control of diverse components occurs, replace costly and, in particular, heavy-weight cable harnesses.

Known from EP 0 2 006 691 is a connector arrangement for flat flex cables by means of which two such ribbon cables are connected to each other. For this purpose, respective conductor strands are stripped of insulation at the connecting site between the ribbon cables and these sites are pressed together by a clamp under application of an elastic pressure.

This simple method of connection has proven itself useful, but can be applied only to a connection of flat flex cables placed under one another.

The present invention is based on the problem of further developing a generic connector arrangement in such a way that, with it, flat flex cables can be manufactured with circuit boards as well.

This problem is solved in accordance with the claims.

Characterized in the subclaims are features of preferred embodiments of the present invention. The present invention is based on the basic idea of affixing a housing to the cable ends of the connecting flexible ribbons, in which the region that is to be contacted is subjected to an elastic spring force, by means of which this region is pressed against the contact surfaces of a mating plug in such a way that the housing is pressed on the latter via an uptake in the region of the mating contact.

The invention will be described in greater detail below on the basis of the description of two embodiment examples with reference to the drawing. Shown therein is the following:

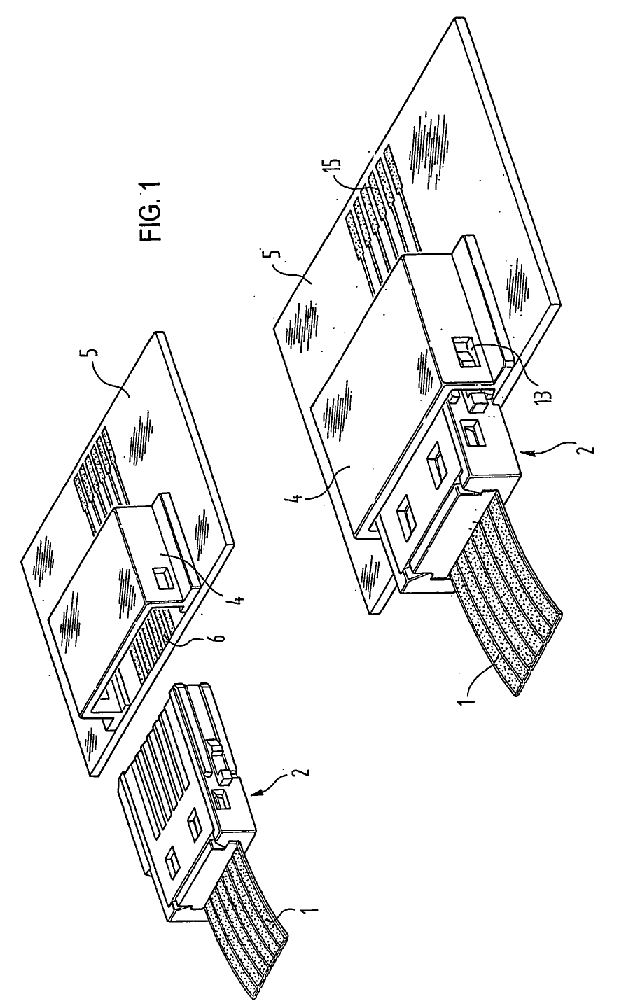

FIG. 1 shows a first embodiment example of a connector arrangement of the invention prior to connection and in contacted position; and

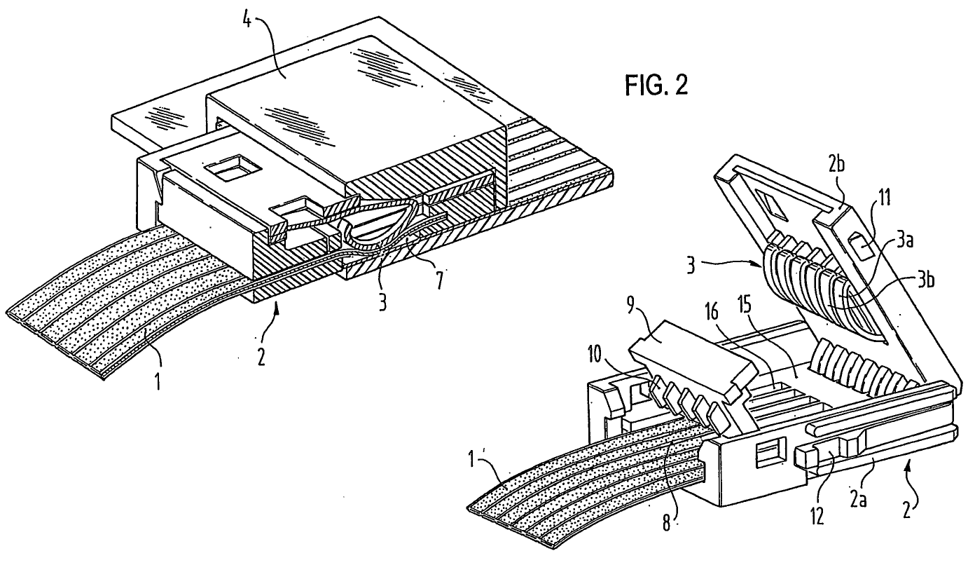

FIG. 2 shows the connector arrangement in perspective, partially cut away and in opened position.

FIG. 1, top left, shows a flat flex cable 1, to the front end of which a housing 2 is attached. The housing 2 has an opening on its bottom, which is not visible here, through which regions of the flat flex cable 1 stripped of insulation protrude downward above the floor of the housing 2. An electrical component, a circuit board 5 in the example shown here, has conductive tracks with contact surfaces 6. An uptake 4 is attached to the circuit board 5 above these contact surfaces 6 by, for example, adhesive bonding. This uptake 4 has the form of a wide bracket that extends over the contact surfaces 6. The housing 2 is inserted into the empty space between the contact surfaces 6 and the upper cross wall of the bracket. This operation is shown in FIG. 1, bottom right. In its final position, the housing 2 is locked in the uptake 4 by catch arms that are affixed to the sides walls of the housing and that spring into a catch opening 13.

FIG. 2, top left, shows the final position of the housing 2 in the uptake 4, partially cut away. Evident there is also the fact that the uptake 4 can also be closed on its front side. Attached to the inside of the housing 2 is a steel spring 3, the free end of which is bent back in a convex manner in a direction opposite to the plugging direction, so that, in the region of an opening 7 in the floor of the housing 2, the bulging region of the steel spring 3 presses on the flat flex cable 1 and the latter, with its conductive tracks that have been stripped of insulation in this region, presses through the opening 7 until these regions protrude above the floor.

When the housing 2 is inserted into the uptake 4, the pressing force exerted by the steel spring 3 is at first relatively small. Only toward the end of the motion of insertion does the back side of each steel spring 3 contact a ramp 17 that is constructed on the uptake and that bends the steel spring 3 further downward and thus produces the requisite contact force. In this way, an initially small insertion force and a lower wear due to friction against the contact surface is achieved. As can be seen in FIG. 1, it is possible to provide one opening per spring through which the spring is pressed by the one ramp for each steel spring 3; however, it is also possible to provide one ramp and one opening for all steel springs.

Shown in FIG. 2, bottom right, is the opened housing 2. The housing 2 consists of a bottom part 2a, into which the insertion end of the flat flex cable is inserted. The cable end has perforations 8 in defined relative positions with respect to the head end of the flat flex cable 1, in which the retaining pins 10 of a strain relief 9 engage. The latter is hinged to the body of the bottom part 2a of the housing 2 transverse to the lengthwise direction of the ribbon cable and can be pivoted after insertion of the flat flex cable 1 into the housing 2, thereby allowing the retaining pins 10 to engage in the perforations 8. In this position, the strain relief 9 is locked on the side flanks of the bottom part 2a of the housing 2. The top part 2b of the housing 2 is hinged in a pivoting manner to the front end of the bottom part 2a of the housing 2. The steel spring 3 is also attached in the top part. In the example shown here, the steel spring 3 takes the form of a comb; that is, a number of spring steel strips 3a, 3b, . . . , corresponding to the number of conductive tracks, are arranged parallel to one another, so that each conductive track being connected is subject individually to the pressure of its own steel strip spring. The guiding of the individual spring strips is achieved in the embodiment example shown by way of ribs arranged between them and by an intermediate plate 15 with slots 16, into which the spring arches of the individual spring strips 3a, 3b can dip during pivoted closure of the top housing part 2b and are laterally guided. The top part 2b of the housing 2 is also locked in the bottom part 2a via catches 11 and corresponding catch shoulders. The housing 2 is guided through the uptake 4 with little play, so that the exposed conductor regions are pressed on corresponding contact surfaces 6 of the circuit board shown in FIG. 1 owing to an elastic spring force. A simple and secure contacting is ensured in this way.

The description of this embodiment example of the present invention serves only for purposes of illustration and is not to be understood as being limiting.

1. A connector arrangement between a flat flex cable and a component of an electrical circuit, wherein the flat flex cable has conductor regions stripped of insulation on one side of its end being connected, comprising a housing in which the end of the flat flex cable is clamped and in which an elastic element (subjects the stripped regions to pressure,
the component comprising an uptake for the housing, in which the housing can be locked and in which contact tracks are arranged, against which the stripped regions of the flat flex cable are pressed when the housing is in the final position thereof in the uptake, characterized in that the component (5) is an electrical circuit board and the uptake forms a bracket, which is attached to the circuit board above an arrangement of conductive tracks and the housing is guided laterally and perpendicularly with respect to the circuit board.

2. The connector arrangement according to claim 1, further characterized in that the housing has a bottom part with at least one opening in the floor, through which the regions of the flat flex cable stripped of insulation can be pressed, and a top part, attached to the bottom part, which has the spring elements opposite the opening, with which the flat flex cable is subjected to pressure.

3. The connector arrangement according to claim 1, further characterized in that the flat flex cable has perforations on its end that is introduced into the housing, in which a strain relief with retaining pins, which is hinged on the bottom housing part, engages in a lockable manner.

4. The connector arrangement according to claims 1, further characterized in that the elastic element consists of one or more steel leaf springs.

5. The connector arrangement according to claims 1, further characterized in that the top housing part is hinged on its front side to the bottom housing part and can be locked in place via catch hooks on the bottom housing part.

6. The connector arrangement according to claim 1, further characterized in that the housing can be locked in place via catch arms in catch openings on the side walls of the bracket.

7. The connector arrangement according to claims 1, further characterized in that, on the top inner side of the uptake, there is constructed at least one ramp, which presses, through at least one opening in the top side of the housing, all or individual steel springs downward on the flat flex cable stripped of insulation.
